(19) United States
(12) Patent Application Publication
(10) Pub. No.: US 2020/0376516 A1
(43) Pub. Date: Dec. 3, 2020

(54) SPRAY COATING MODULE WITH MULTI-ORIFICE PASSAGEWAYS

(71) Applicant: PRECISION MACHINERY RESEARCH & DEVELOPMENT CENTER, TAICHUNG (TW)

(72) Inventors: SHEN-YU CHEN, TAICHUNG (TW); JEN-CHUNG HSIAO, TAICHUNG (TW); KEISUKE NARUSE, TAICHUNG (TW); PEI-CHUN LAI, TAICHUNG (TW); KAI-JIE TSAO, TAICHUNG (TW)

(21) Appl. No.: 16/426,842

(22) Filed: May 30, 2019

(51) Int. Cl. B05B 17/06; B05B 1/20

(52) U.S. Cl. CPC B05B 17/0623; B05B 1/20; B05B 17/0676

(57) ABSTRACT

A spray coating module with multi-orifice passageways includes an ultrasonic vibrating unit having an ultrasonic horn, and a material feeding unit having a material inputting passageway, a plurality of material outputting passageways, a dividing passageway and a material outputting end surface. The dividing passageway communicates with the material inputting passageway and each material outputting passageway. The material inputting passageway has a material inputting orifice. Each material outputting passageway has a material outputting orifice formed on the material outputting end surface. The cross-sectional area of the material inputting orifice is larger than the sum of the cross-sectional areas of the material outputting orifices. A gap is kept between the material outputting end surface and the ultrasonic horn. As a result, the present invention is effectively prevented from the non-uniform material feeding condition of the traditional elongated material feeding unit and relatively better in spray coating uniformity.

### BACKGROUND OF THE INVENTION

### 1. Field of the Invention

The present invention relates to a spray coating machine and more particularly, to a spray coating module of a spray coating machine, which has multi-orifice passageways.

### 2. Description of the Related Art

In recent years, with the rise of environmental awareness and the miniaturization and meticulousness of technical products, ultrasonic spray coating modules are widely used in various industrial fields. The ultrasonic spray coating modules relate to a non-vacuum coating technology, which can highly atomize coating material into mist and then form a film by accumulating the atomized particles on the surface of the coated object. This technology is high in material utilization rate, not only filling the requirements of reduced consumption of expensive material and environmental protection, but also capable of large-area production. Besides, it can replace the existing vacuum coating technology to reduce the investment cost of coating equipment. Therefore, the ultrasonic spray coating technology is a very competitive spray coating technology in precision coating applications.

The structure of the conventional ultrasonic spray coating module, such as that disclosed in US Patent Publication No. 5409163, includes two air nozzles and a fishtail material feeding unit. The fishtail material feeding unit is driven by an ultrasonic vibrating member to perform ultrasonic vibration. The fishtail material feeding unit is provided therein with a slotted passageway. The slotted passageway is adapted for a liquid material to be entered thereinto. After receiving the ultrasonic vibration, the liquid material is atomized, thereby delicately formed into atomized droplets. The two air nozzles provide air flows in two different directions. One of the air flows serves as guiding air for blowing the atomized droplets to the coated area. The other air flow is used to blow the terminal end of the slotted passageway to prevent the atomized droplets from flowing along the terminal end of the slotted passageway back to the bottom surface of the fishtail material feeding mold and thereby being formed into dripping flow.

In this publication patent, the fishtail material feeding mold is adopted, as shown in FIGS. 12, 13a and 13b of the patent. The passageway of the fishtail material feeding mold is gradually widened from the inside to the outside thereof. Two sides of the passageway define an included angle Φ therebetween, as shown in FIG. 13a of the patent. The orifice of the passageway is elongated. Such configuration is liable to cause non-uniform flow rate of the liquid material at each position of the elongated orifice of the passageway. In particular, the liquid material at two ends of the elongated orifice of the passageway is liable to be towed by the shear stress of two side walls, resulting in relatively less amount of the liquid material on the two sides of the orifice of the passageway. Besides, since the liquid material cannot be uniformly supplied to the ultrasonic vibrating member, the final coating uniformity is also affected. Therefore, it is needed to propose a solution to improve the material feeding uniformity.

### SUMMARY OF THE INVENTION

Therefore, it is an objective of the present invention to provide a spray coating module with multi-orifice passageways, which is effectively prevented from the non-uniform material feeding condition of the conventional spray coating module, thereby enhanced in spray coating uniformity.

To attain the above objective, the present invention provides a spray coating module with multi-orifice passageways, which includes an ultrasonic vibrating unit and a material feeding unit. The ultrasonic vibrating unit has an ultrasonic horn. The material feeding unit has a material inputting passageway, a plurality of material outputting passageways, a dividing passageway and a material outputting end surface. The dividing passageway communicates with the material inputting passageway and each of the material outputting passageways. The material inputting passageway has a material inputting orifice. Each of the material outputting passageways has a material outputting orifice formed on the material outputting end surface. The cross-sectional area of the material inputting orifice is larger than the sum of the cross-sectional areas of the material outputting orifices. A gap is kept between the material outputting end surface and the ultrasonic horn.

Through the afore-described configuration of the present invention adopting the material feeding unit with a plurality of material outputting orifices, the coating material is compulsorily divided to flow to the material outputting orifices. That decreases the influence caused by the shear stress of the side walls of single passageway orifice, thereby effectively prevented from the non-uniform material feeding condition. Besides, the present invention raises the flow speed of the coating material at the material outputting orifices by the structural feature that the cross-sectional area of the material inputting orifice is larger than the sum of the cross-sectional areas of the material outputting orifices. That can not only further decrease the influence caused by the shear stress of the side walls, but also decrease the lateral flowing force of the coating material at the blade of the ultrasonic horn. Therefore, the spray coating module with multi-orifice passageways of the present invention is effectively prevented from the non-uniform material feeding condition of the traditional elongated material feeding unit and relatively better in spray coating uniformity.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The spray coating module with multi-orifice passageways provided by the present invention will be further described by the embodiment and the accompanying drawings given herein below, and wherein:

FIG. 1 is a perspective view of a spray coating module with multi-orifice passageways of an embodiment of the present invention;

FIG. 2 is a sectional side view of the embodiment of the present invention;

FIG. 3 is an enlarged perspective view of a part of the embodiment of the present invention, primarily showing the structure of a material feeding unit;

FIG. 4 is a front view of the material feeding unit shown in FIG. 3;

FIGS. 5-7 are similar to FIG. 4, primarily showing different shapes of material outputting orifices provided on a material outputting end surface of the material feeding unit;

FIG. 8 is a partially enlarged sectional view of FIG. 2, primarily showing the relative relation between the material outputting orifice of the material feeding unit and an ultrasonic horn.

### DETAILED DESCRIPTION OF THE INVENTION

First of all, it is to be mentioned that the technical features provided by the present invention are unlimited to the specific structure, usage and application thereof described in the detailed description of the invention. It should be understood by those skilled in the related art that all the terms used in the contents of the specification are for illustrative description. The directional terms mentioned in the contents of the specification, such as ‘front’, ‘upper’, ‘lower’, ‘rear’, ‘left’, ‘right’, ‘top’, ‘bottom’, ‘inside’, and ‘outside’, are also just for illustrative description on the basis of normal usage direction, not intended to limit the claimed scope.

Besides, the numeral terms with singular form, such as ‘a’, ‘an’ and ‘the’, used in the claims of the present invention all include the plural meaning. Thus, for example, the description for ‘an element’ refers to one or a plurality of elements and includes the equivalent replacements known by those skilled in the related field. All conjunctions used in similar conditions should also be understood in the broadest sense. The specific shapes and structural features or technical terms described in the contents of the specification should also be understood to include the equivalently replacing structures or technical terms capable of attaining the function of the specific structures or technical terms.

Referring to the figures, a spray coating module 10 with multi-orifice passageways of an embodiment of the present invention includes a base 12, an ultrasonic vibrating unit 20, a material feeding unit 30, and a gas guiding unit 50.

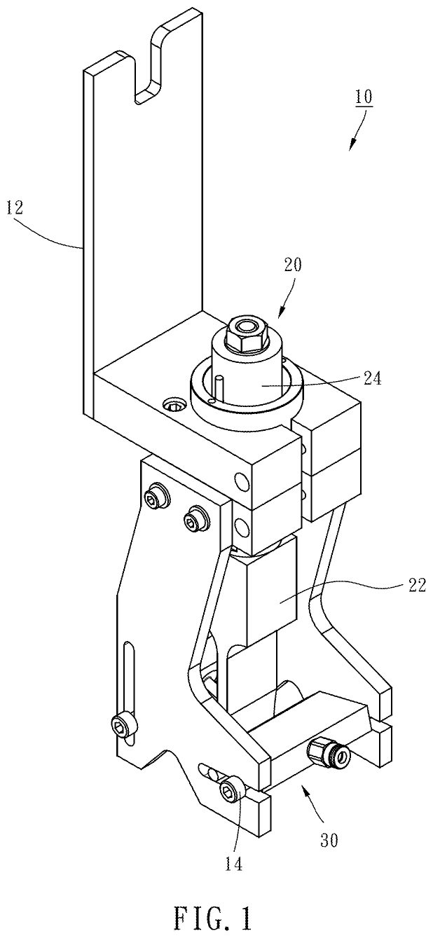

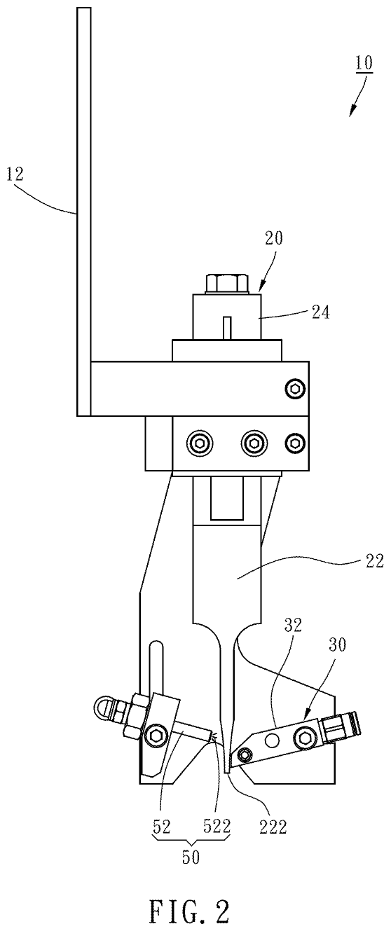

Referring to FIGS. 1 and 2, the ultrasonic vibrating unit 20 has an ultrasonic horn 22. In this embodiment, the ultrasonic vibrating unit 20 further includes a piezoelectric transducer 24. The ultrasonic horn 22 and the piezoelectric transducer 24 are disposed on the base 12. The piezoelectric transducer 24 can convert electrical energy to mechanical vibration. The top end of the ultrasonic horn 22 is connected to the piezoelectric transducer 24. The ultrasonic horn 22 is provided at a bottom end thereof with an atomizing blade 222. The liquid coating material located at the atomizing blade 222 is atomized in a way that the piezoelectric transducer 24 drives the ultrasonic horn 22 to vibrate and then the atomizing blade 222 of the ultrasonic horn 22 amplifies the particle displacement or speed of the mechanical vibration.

Referring to FIGS. 1-3, the material feeding unit 30 is disposed on the base 12. The material feeding unit 30 is adjustable in position and angle thereof relative to the base 12 according to usage requirements. In this embodiment, the material feeding unit 30 is fastened to the base 12 by fasteners 14 located on two sides of the base.

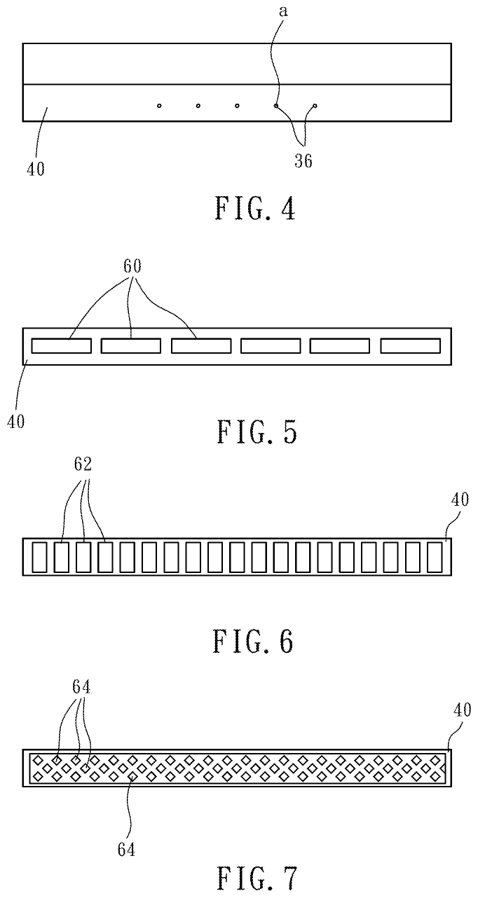

The material feeding unit 30 has a main body 32, a material inputting passageway 34, a plurality of material outputting passageways 36, a dividing passageway 38 and a material outputting end surface 40. The dividing passageway 38 communicates with the material inputting passageway 34 and each of the material outputting passageways 36. The material inputting passageway 34 has a material inputting orifice 342. Each of the material outputting passageways 36 has a material outputting orifice 362 formed on the material outputting end surface 40. In this embodiment, the material feeding unit 30 has five material outputting orifices 362. The cross-sectional area of the material inputting orifice 342 is ‘A’. The cross-sectional area of each of the material outputting orifice is ‘a’ (as shown in FIG. 4), so the sum of the cross-sectional areas of the material outputting orifices is ‘5a’. The cross-sectional area ‘A’ of the material inputting orifice 342 is larger than the sum ‘5a’ of the cross-sectional areas of the material outputting orifices 362. A gap is kept between the material outputting end surface 40 and the ultrasonic horn 22. The coating material to be atomized is entered through the material inputting orifice 342, flows through the material inputting passageway 34, the dividing passageway 38 and the material outputting passageways 36, and at last flows out through the material outputting orifices 362.

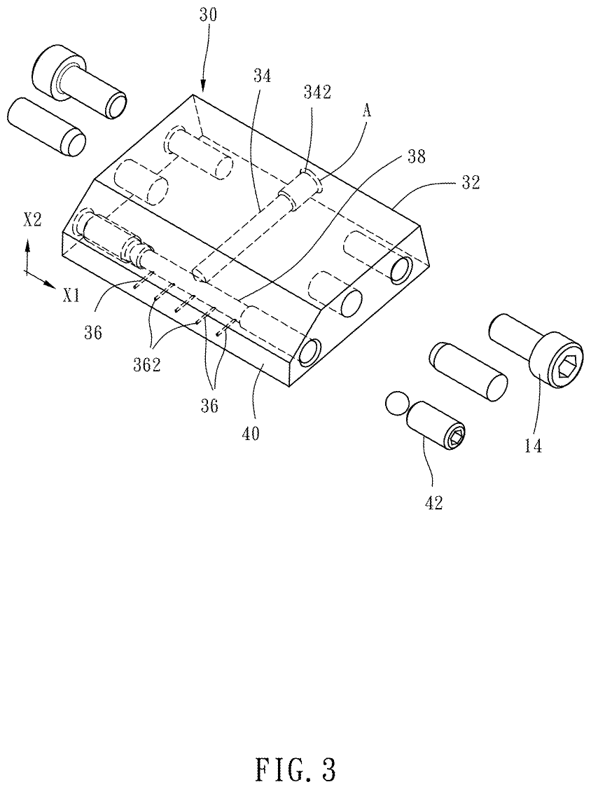

In this embodiment, if the quotient of dividing the sum ‘5a’ of the cross-sectional areas of the material outputting orifices 362 by the cross-sectional area ‘A’ of the material inputting orifice 342 is in the range from 5% to 30%, the material feeding uniformity of the material feeding unit 30 is effectively enhanced. If the quotient of dividing the sum ‘5a’ of the cross-sectional areas of the material outputting orifices 362 by the cross-sectional area ‘A’ of the material inputting orifice 342 is in the range from 8% to 16%, the material feeding uniformity of the material feeding unit 30 is relatively better. The material outputting end surface 40 is defined with a major axis direction X1 from the left to the right and a minor axis direction X2 from the bottom to the top, as shown in FIG. 3. The minor axis direction X2 may, but unlimited to, be parallel to a vertical line. The major axis direction X1 may, but unlimited to, be parallel to a horizontal plane. The minor axis direction X2 and the major axis direction X1 are modifiable according to manufacture or usage requirements. Besides, the five material outputting orifices 362 are circularly shaped and arranged in the major axis direction X1 at equal intervals therebetween. It should be additionally remarked that the amount and shape of the material outputting orifices 362 and the arranged relation therebetween are unlimited to those provided in this embodiment. In other potential embodiments, the material outputting orifices 362 may be shaped as transversely elongated holes as shown in FIG. 5, shaped as vertically elongated holes as shown in FIG. 6, mesh-shaped as shown in FIG. 7, or even mix of multiple kinds of differently shaped material outputting orifices (not shown). Besides, the material outputting orifices 362 are unlimited to be arranged in only one transverse row in the major axis direction X1, but may be arranged in at least two rows in a way that the at least two rows are arranged vertically in the minor axis direction X2 as shown in FIG. 7. The intervals between the rows of the material outputting orifices 362 and the relative relation of the positional arrangement thereof are also modifiable according to manufacture and usage requirements.

Referring to FIG. 2, the gas guiding unit 50 has a gas nozzle 52. The gas nozzle 52 ejects a guiding gas 522 in a spray coating direction and the guiding gas is aimed at the atomizing blade 222. The orientation of the gas nozzle 52 is optionally arranged according to the demanded spray coating direction, which is functioned primarily for providing the guiding gas 522. By the guiding gas 522, the atomized coating material is guided toward the object to be coated.

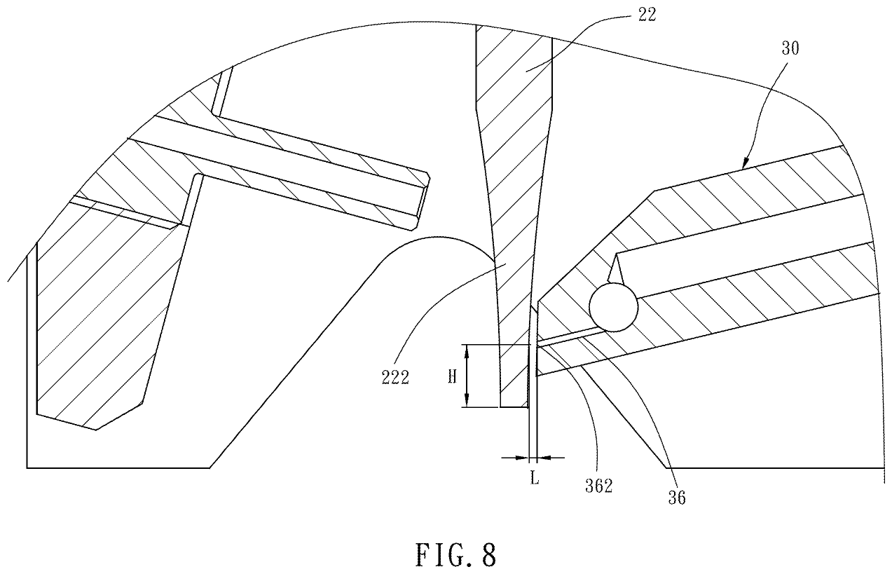

Referring to FIGS. 2 and 8, it should be additionally remarked that for the relatively more effective atomization of the coating material, the horizontal distance L between the material outputting orifice 362 and the ultrasonic horn 22 is larger than 0 mm and smaller than or equal to 5 mm, and the vertical distance H between the material outputting orifice 362 and the bottom edge of the atomizing blade 222 of the ultrasonic horn 22 is larger than 0 mm and smaller than or equal to 12 mm. If the aforesaid distances beyond the associated ranges, the spray coating module with multi-orifice passageways is still workable, but the atomizing effect and the coating uniformity may be relatively lower. Besides, as shown in FIG. 3, for decreasing the assembly error and avoiding the leakage in high pressure condition, the material feeding unit 30 of the present invention is an integrated structure, which can be manufactured with the material inputting passageway 34, the dividing passageway 38 and the material outputting passageways 36 by the process such as drilling or boring performed on the main body 32. At last, two sealing members 42 are disposed at two ends of the dividing passageway 38 respectively. Therefore, the present invention is simple in manufacturing process, thereby effectively lowered in manufacturing cost. Besides, the integrated structure is relatively better in structural strength. In contrast, the fishtail material feeding mold disclosed in the description of the related art needs upper and lower dies which are manufactured separately, not only complicated in manufacturing process but also relatively higher in processing cost. When the upper and lower dies are combined, there is liable assembly error and relatively weaker structural strength. Obviously, compared with the prior arts, the present invention certainly has remarkable advantages.

The above description is about the structure of this embodiment, and the following description is about the operating steps of this embodiment. Refer to FIGS. 2 and 3.

At first, the coating material is entered into the material inputting passageway 34 through the material inputting orifice 342. Then, the coating material continues to flow through the dividing passageway 38 to enter the material outputting passageways 36. At last, the coating material flows out through the material outputting orifices 362. At this time, because the gap is kept between the material outputting end surface 40 and the atomizing blade 222, the coating material located on the material outputting end surface 40 will be in contact with the atomizing blade 222 and thereby atomized. The coating material after being atomized will be sent in the spray coating direction by the guiding gas 522 of the gas nozzle 52.

In conclusion, compared with the prior arts, the present invention includes at least the following advantages.

1. Through the structure of the material feeding unit with the plurality of material outputting orifices, the coating material is compulsorily divided to flow to the material outputting orifices. That decreases the influence caused by the shear stress of the side walls of single passageway orifice, thereby effectively prevented from the non-uniform material feeding condition.

2. Through the structural feature that the cross-sectional area of the material inputting orifice is larger than the sum of the cross-sectional areas of the material outputting orifices, the flow speed of the coating material at the material outputting orifices is raised, especially the flow speed of the coating material along the axis of the material outputting passageways, so that the influence caused by the shear stress of the side walls is further decreased. Besides, the relatively higher axial flow speed can also decrease the lateral flowing force of the coating material at the blade of the ultrasonic horn. Therefore, the spray coating module with multi-orifice passageways of the present invention is effectively prevented from the non-uniform material feeding condition of the traditional elongated material feeding unit and relatively better in coating uniformity. In addition, for the coating material with relatively larger viscous force or relatively stronger cohesive force, the non-uniform material feeding condition of the conventional fishtail material feeding mold is serious, but the present invention is effectively prevented from such non-uniform material feeding condition.

3. The integrated structure of the material feeding unit can effectively reduce the processing complication, lower the manufacturing cost, avoid assembly error of multi-die, and also raise the structural strength of the material feeding unit.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A spray coating module with multi-orifice passageways, which is characterized in that the spray coating module comprises:
an ultrasonic vibrating unit and a material feeding unit;
the ultrasonic vibrating unit has an ultrasonic horn;
the material feeding unit has a material inputting passageway, a plurality of material outputting passageways, a dividing passageway and a material outputting end surface; the dividing passageway communicates with the material inputting passageway and each of the material outputting passageways; the material inputting passageway has a material inputting orifice; each of the material outputting passageways has a material outputting orifice formed on the material outputting end surface; a cross-sectional area of the material inputting orifice is larger than a sum of cross-sectional areas of the material outputting orifices; a gap is kept between the material outputting end surface and the ultrasonic horn.

2. The spray coating module as claimed in claim 1, which is characterized in that a quotient of dividing the sum of the cross-sectional areas of the material outputting orifices by the cross-sectional area of the material inputting orifice is ranged from 5% to 30%.

3. The spray coating module as claimed in claim 2, which is characterized in that the ultrasonic vibrating unit includes a piezoelectric transducer; the ultrasonic horn is disposed on the piezoelectric transducer; the ultrasonic horn is provided at an end thereof with an atomizing blade.

4. The spray coating module as claimed in claim 3, which is characterized in that the spray coating module further includes a gas guiding unit; the gas guiding unit has a gas nozzle; the gas nozzle ejects a guiding gas in a spray coating direction and the guiding gas is aimed at the atomizing blade.

5. The spray coating module as claimed in claim 2, which is characterized in that the material outputting end surface is defined with a major axis direction; the material outputting orifices are arranged in the major axis direction.

6. The spray coating module as claimed in claim 5, which is characterized in that in the major axis direction, the material outputting orifices are arranged at equal intervals therebetween.

7. The spray coating module as claimed in claim 2, which is characterized in that the material outputting orifices are arranged in at least two rows.

8. The spray coating module as claimed in claim 2, which is characterized in that a horizontal distance between the material outputting orifice and the ultrasonic horn is larger than 0 mm and smaller than or equal to 5 mm.

9. The spray coating module as claimed in claim 3, which is characterized in that a vertical distance between the material outputting orifice and a bottom edge of the ultrasonic horn is larger than 0 mm and smaller than or equal to 12 mm.

10. The spray coating module as claimed in claim 2, which is characterized in that the material feeding unit is an integrated structure.
